(19) United States
(12) Patent Application Publication
(10) Pub. No.: US 2019/0324511 A1
(43) Pub. Date: Oct. 24, 2019

(54) CONTROLLER, CONTROL METHOD, AND CONTROL PROGRAM

(71) Applicant: RENESAS ELECTRONICS CORPORATION, Tokyo (JP)

(72) Inventor: Qi CAO, Tokyo (JP)

(21) Appl. No.: 16/372,176

(22) Filed: Apr. 1, 2019

(30) Foreign Application Priority Data
Apr. 18, 2018 (JP) 2018-080002

(51) Int. Cl. G06F 1/26; G06F 1/28; G06F 13/42

(52) U.S. Cl. CPC G06F 1/266; G06F 2213/0042; G06F 13/4282; G06F 1/28

(57) ABSTRACT

A controller is provided to execute sequences compliant with a USB standard and establish a connection with a connection destination. The controller includes a signal transmission module that exchanges signals with the connection destination via a communication line in a USB cable. A sequence controller disables the function of the signal transmission module to detect the existence of the connection destination when the existence of the connection destination is detected while no connection is established with the connection destination. The sequence controller instructs a power supply unit to output a first voltage and electrically couples the power supply unit with an electric power line when it is determined that an output voltage from the power supply unit reaches the first voltage.

### CROSS-REFERENCE TO RELATED APPLICATIONS

The disclosure of Japanese Patent Application No. 2018-080002 filed on Apr. 18, 2018 including the specification, drawings and abstract is incorporated herein by reference in its entirety.

### BACKGROUND

The present disclosure relates to a controller and is used to execute a sequence according to the USB (Universal Serial Bus) standard and establish a connection to a connection destination, for example.

There is a widespread use of USB (Universal Serial Bus) as an interface to connect a personal computer with peripheral devices, for example. The USB Implementers Forum (USB-IF) establishes standards concerning USB.

Among presently established USB standards, USB revision 3.1 specifies a new standard (hereinafter also referred to as a “USB Type-C standard”) that includes a new connector shape called a USB Type-C port (see Nonpatent Literature 1, for example).

The USB Type-C standard is capable of using USB Power Delivery (hereinafter also referred to simply as “PD”), a power feed standard to exchange electric power by using a USB cable (see Nonpatent Literature 2, for example). The USB PD standard is comparable to a USB electric power extended standard. The present USB PD standard is capable of supplying an electric power of up to 100 W. The USB Type-C standard is capable of exchanging not only data as usual but also electric power with a battery or a mobile device.

There is also a widespread use of the Qi standard capable of wireless power feed, supplying electric power to a battery or a mobile device in a contactless manner. The Qi standard is a global standard for wireless power feed established by Wireless Power Consortium (WPC) (see Nonpatent Literature 3, for example). The present Qi standard is capable of wirelessly supplying an electric power of up to 15 W. A subject of future investigation is to further increase the amount of electric power that can be supplied.

### CITATION LIST

### Nonpatent Literature

Nonpatent Literature 1: “Universal Serial Bus Type-C Cable and Connector Specification”, Release 1.3, Jul. 14, 2017
Nonpatent Literature 2: “Universal Serial Bus Power Delivery Specification, Revision: 3.0”, Version: 1.1, Release date: 12 Jan. 2017
Nonpatent Literature 3: Wireless Power Consortium, “The Qi Wireless Power Transfer System Power Class 0 Specification”, Version 1.2.3, February 2017

### SUMMARY

The USB PD standard and the Qi standard specify respective power feed procedures but are uninterested in the consistency with the other standards. The inventors of the present application found a new issue of implementing the USB Type-C standard and the USB PD standard by using a power supply based on wireless power feed compliant with the Qi standard.

These and other objects and novel features may be readily ascertained by referring to the following description of the present specification and appended drawings.

An embodiment provides a controller that executes sequences compliant with the USB standard and establishes a connection with a connection destination. The controller includes a signal transmission module that exchanges signals with the connection destination via a communication line in a USB cable. The signal transmission module can detect the presence of a connection destination based on characteristic changes occurring on a communication line. The controller includes a power supply control module to control a power supply unit that supplies electric power via an electric power line inside the USB cable; and a sequence controller. The sequence controller disables the function of the signal transmission module to detect the existence of the connection destination when the existence of the connection destination is detected while no connection is established with the connection destination. The sequence controller instructs a power supply unit to output a first voltage and electrically couples the power supply unit with an electric power line when it is determined that an output voltage from the power supply unit reaches the first voltage.

According to an embodiment, the USB Type-C standard and the USB PD standard can be implemented for even a power supply such as wireless power feed that does not so fast change an output voltage.

### BRIEF DESCRIPTION OF THE DRAWINGS

FIG. 1 is a schematic diagram illustrating a general configuration of a power supply system according to the present embodiment;

FIG. 2 is a schematic diagram illustrating a procedure to supply electric power according to the USB PD standard;

FIG. 3 is a diagram illustrating a major part of state transition for a PD controller functioning as SRC according to the USB Type-C standard;

FIG. 4 is a diagram illustrating a major part of state transition for a PD controller functioning as SNK according to the USB Type-C standard;

FIG. 5 is a schematic diagram illustrating voltage changes on VBUS when performing a negotiation according to the USB PD standard between PD controllers coupled according to the USB Type-C standard;

FIG. 6 is a flowchart illustrating more detailed contents of a Source-to-Sink.Attached sequence and a PowerNegotiation sequence to change a voltage;

FIG. 7 is a time chart illustrating voltage changes on VBUS when the sequence in FIG. 6 is performed by using electric power output from VOUT of a reception module for a wireless power feed function;

FIG. 8 is a schematic diagram illustrating a hardware configuration of a power supply device according to a first embodiment;

FIG. 9 is a flowchart illustrating a major part of the procedure as a connection sequence performed by the PD controller of the power supply device according to the first embodiment;

FIG. 10 is a schematic diagram illustrating a circuit configuration of a signal transmission module in the PD controller of the power supply device according to the first embodiment;

FIG. 11 is a time chart illustrating voltage changes in VBUS and VOUT occurring when the PD controller of the power supply device according to the first embodiment performs a connection sequence;

FIG. 12 is a diagram illustrating state transition when the PD controller of the power supply device according to the first embodiment performs a Source-to-Sink.Attached sequence;

FIG. 13 is a schematic diagram illustrating a hardware configuration of the power supply device according to a first modification of the first embodiment;

FIG. 14 is a schematic diagram illustrating a hardware configuration of the power supply device according to a second embodiment;

FIG. 15 is a schematic diagram illustrating a hardware configuration of a mobile device according to a third embodiment;

FIG. 16 is a schematic diagram illustrating a first mode of power delivery and reception operation on the mobile device according to the third embodiment;

FIG. 17 is a schematic diagram illustrating a second mode of power delivery and reception operation on the mobile device according to the third embodiment; and

FIG. 18 is a schematic diagram illustrating a third mode of power delivery and reception operation on the mobile device according to the third embodiment.

### DETAILED DESCRIPTION

Some embodiments will be described in further detail with reference to the accompanying drawings. The same or comparable parts in the drawings are depicted by the same reference numerals and the description is omitted.

### A. Outline of the Power Supply System

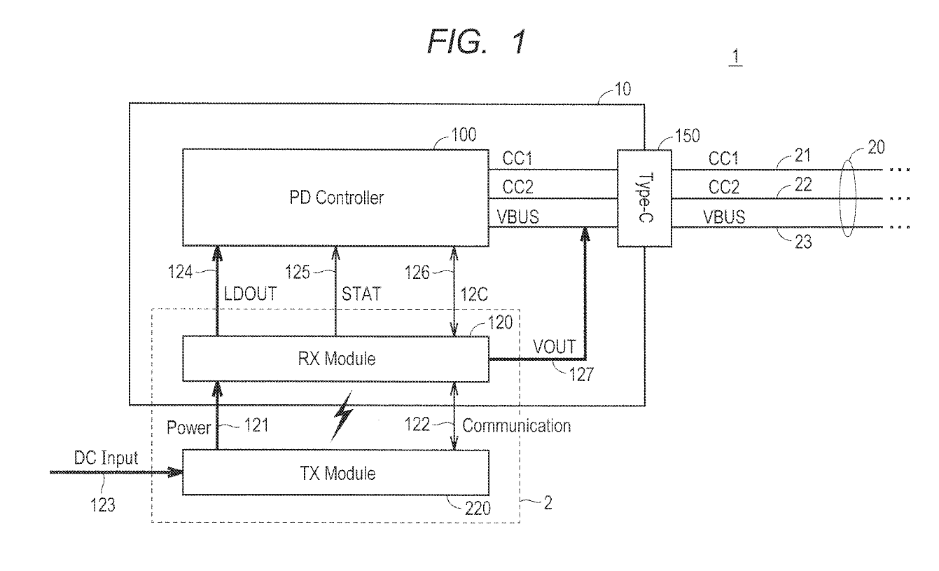

The description below outlines the power supply system according to the present embodiment. FIG. 1 is a schematic diagram illustrating a general configuration of a power supply system 1 according to the present embodiment. As seen from FIG. 1, the power supply system 1 includes a power supply device 10 as a major component. The power supply device 10 includes a wireless power feed function (that is, a power reception function according to the Qi standard) and a power delivery and reception function (namely, a USB PD function) via USB.

More specifically, the power supply device 10 includes a PD controller (PD Controller) 100 to provide the USB PD function and a reception module (RX Module) 120 for wireless power feed.

The PD controller 100 performs a sequence according to the USB standards (the USB Type-C standard and the USB PD standard in the present embodiment) to establish the connection with a connection destination. The sequence performed by the PD controller 100 will be described later in detail.

The reception module 120 is comparable to a power supply unit that supplies electric power via a VBUS 23 as an electric power line in a USB cable 20. FIG. 1 illustrates a configuration in which the wireless power feed receives electric power from the outside. The reception module 120 is comparable to a power supply unit that uses the wireless power feed to receive electric power from the outside.

More specifically, the reception module 120 is placed close to a transmission module (TX Module) 220 for wireless power feed. The reception module 120 performs wireless communication 122 with the transmission module 220 to provide a negotiation needed for the wireless power feed and then receives electric power 121 transmitted from the transmission module 220. The transmission module 220 is supplied with electric power 123 from the outside. The transmission module 220 and the reception module 120 configure a wireless power feed system 2.

The reception module 120 includes an LDOOUT 124, a STAT interface 125, an I2C interface 126, and a VDOUT 127.

The LDOOUT 124 outputs electric power for a linear regulator. The STAT interface 125 outputs a signal indicating the state of the reception module 120.

The reception module 120 exchanges various types of control signals with an external device (the PD controller 100 according to the example configuration in FIG. 1) via the I2C interface 126. To function as a slave, the reception module 120 normally accepts requests from the external device to read and write to a register included in the reception module 120 via the I2C interface 126.

The VOUT 127 outputs electric power for the external device. The electric power output from the VDOUT 127 can be used to supply the power to the external device coupled to the power supply device 10. The power supply device 10 according to the present embodiment supplies electric power to the external device by using the electric power output from the VDOUT 127 of the reception module 120 via a USB cable.

The PD controller 100 communicates with the external device and exchanges electric power with the same via the USB cable 20 coupled to a connector 150. The communication uses a first communication line (CC1) 21 and a second communication line (CC2) 22. The first communication line (CC1) 21 and the second communication line (CC2) 22 may be also generically referred to as a “communication line.”

The VBUS 23 as an electric power line is used to exchange the electric power. The USB cable 20 includes an unshown shielded line. The configuration and the process of the PD controller 100 will be described later in detail.

### B. Related Art

The description below explains the USB Type-C standard and the USB PD standard at the present time.

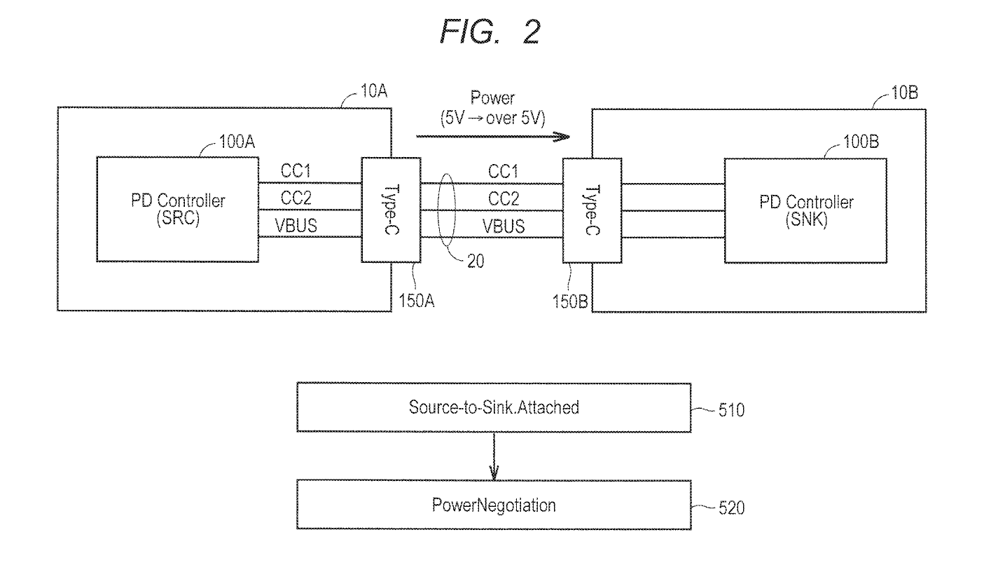

FIG. 2 is a schematic diagram illustrating a procedure to supply electric power according to the USB PD standard. FIG. 2 provides an example of supplying electric power to a receiving device 10B from a supplying device 10A via the USB cable 20. The USB cable 20 electrically couples a connector 150A of the supplying device 10A with a connector 150B of the receiving device 10B.

The USB PD standard specifies three types of PowerRole ports such as SRC, SNK, and DRP. The SRC (Source) port supplies electric power. The SNK (Sink) port receives electric power from the outside. The DRP port can function as SRC and SNK.

According to the example in FIG. 2, the PD controller 100A of the supplying device 10A functions as SRC (or DRP). The PD controller 100B of the receiving device 10B functions as SNK (or DRP).

A state called “Attached” (hereinafter also referred to as “Source-to-Sink.Attached”) is enabled when the PD controller 100A functioning as SRC and the PD controller 100B functioning as SNK are electrically coupled via the USB cable 20. In the Source-to-Sink.Attached state, the PD controller 100A functioning as SRC remains in a state called “Attached.SRC.” The PD controller 100B functioning as SNK remains in a state called “Attached.SNK.”

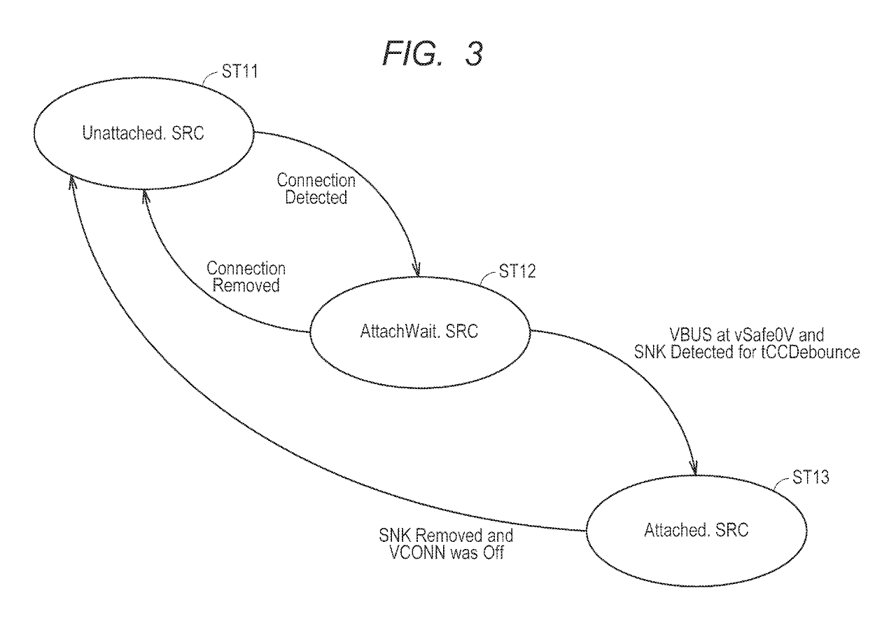

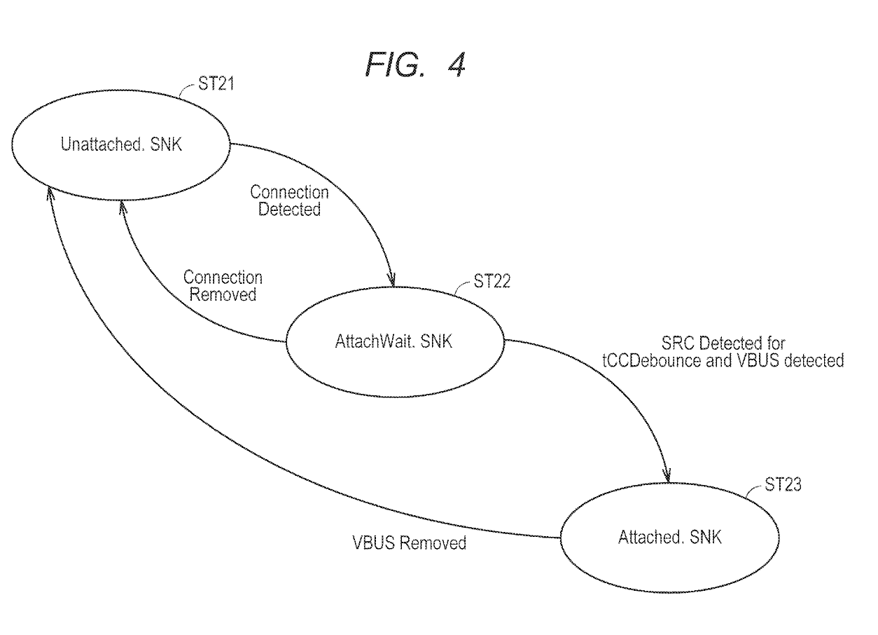

FIG. 3 is a diagram illustrating a major part of state transition for the PD controller functioning as SRC according to the USB Type-C standard. FIG. 4 is a diagram illustrating a major part of state transition for the PD controller functioning as SNK according to the USB Type-C standard.

As seen from FIG. 3, the PD controller functioning as SRC transitions among three states such as an Unattach.SRC state (ST11), an AttachWait.SRC state (ST12), and an Attached.SRC state (ST13).

The Unattach.SRC state (ST11) awaits detection of the PD controller functioning as SNK at the connection destination. In this state, the voltage of the VBUS 23 is set to vSafe0V (namely, no voltage applied). The circuit is formed so that resistance value SNK.Rp occurs on the communication line (CC1/CC2). This state successively detects resistance values appearing at the connection destination via the communication line (CC1/CC2). The state transitions to the AttachWait.SRC state (ST12) when resistance value SRC.Rd (a resistance value at the SRC) is detected on the communication line.

The AttachWait.SRC state (ST12) awaits a stable condition of the communication line (CC1/CC2) after the PD controller functioning as SKN is detected. In this state, the voltage of the VBUS 23 is set to vSafe0V (namely, no voltage applied). The state successively detects resistance values appearing at the connection destination via the communication line (CC1/CC2). The state transitions to the Attached.SRC state (ST13) when resistance value SRC.Rd occurring on the communication line changes to tCCDebounce or more.

The Attached.SRC state (ST13) functions as SRC. In this state, the voltage of the VBUS 23 is set to vSafe5V.

After the transition to the Attached.SRC state, the voltage of the VBUS 23 must be increased to vSafe5V within tVBusON. The present USB Type-C standard specifies tVBusON as 275 ms. This restriction will be described later.

As seen from FIG. 4, the PD controller functioning as SNK transitions among three states such as an Unattach.SNK state (ST21), an AttachWait.SNK state (ST22), and an Attached.SNK state (ST23).

The Unattach.SNK state (ST21) awaits detection of the PD controller functioning as SRC at the connection destination. This state inhibits voltage supply to the VBUS 23. The circuit is formed so that resistance value SRC.Rd occurs on the communication line (CC1/CC2). The state successively detects resistance values appearing at the connection destination via the communication line (CC1/CC2). The state transitions to the AttachWait.SNK state (ST22) when resistance value SNK.Rp (a resistance value at the SNK side) is detected on the communication line.

The AttachWait.SNK state (ST22) awaits a stable condition of the communication line (CC1/CC2) after the PD controller functioning as SRC is detected. In this state, some voltage may be detected on the VBUS 23 or resistance value SNK.Rp occurring on the communication line may change to tCCDebounce or more. In such a case, the state transitions to the Attached.SNK state (ST23).

The Attached.SNK state (ST23) functions as SNK. This state receives an electric power supply of vSafe5V via the VBUS 23.

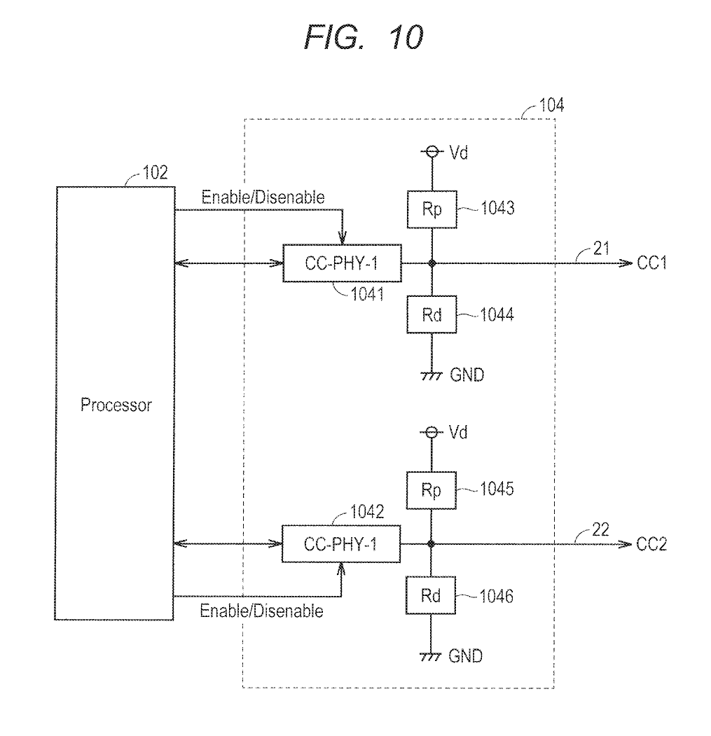

The state of the PD controller functioning as DRP is capable of the transitions in FIGS. 3 and 4. A detailed description is omitted here. The resistance values occurring on the communication line will be described later in detail with reference to FIG. 10, for example.

Referring to FIG. 2 again, suppose a procedure (hereinafter also referred to as a “Source-to-Sink.Attached sequence”) to establish the state of Source-to-Sink.Attached is complete (step S10).

A PowerNegotiation sequence to change the voltage then starts between the PD controller 100A and the PD controller 100B (step S20).

The Source-to-Sink.Attached state sets the voltage of the VBUS 23 to 5V (vSafe5V). The PowerNegotiation sequence changes the voltage to a higher voltage (vSrcNew) and then starts the electric power supply. For example, vSrcNew can be selected from 9 V or 12 V.

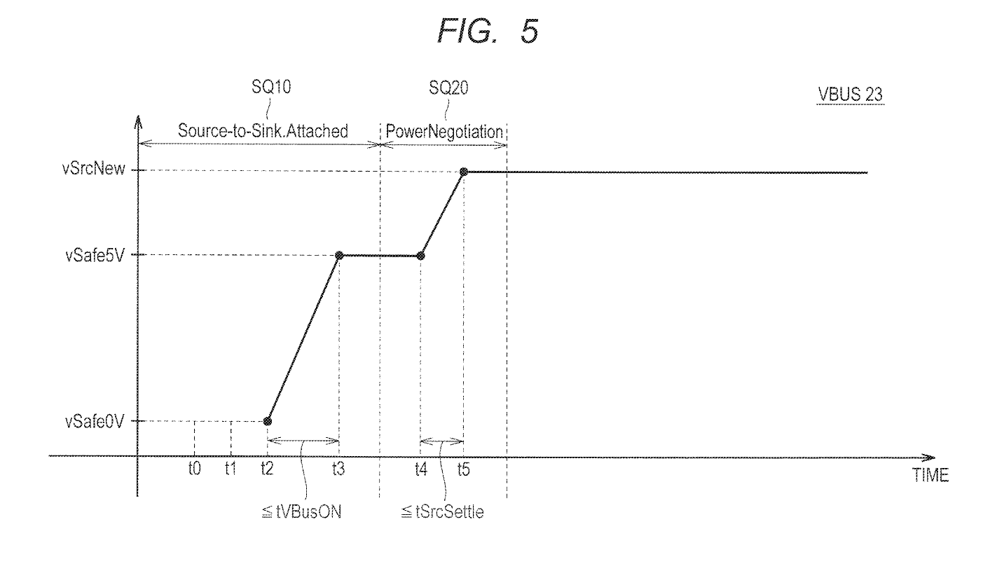

FIG. 5 is a schematic diagram illustrating voltage changes on the VBUS when performing a negotiation according to the USB PD standard between PD controllers coupled according to the USB Type-C standard. Basically, the Source-to-Sink.Attached sequence (step S10) and the PowerNegotiation sequence (step S20) to change the voltage are performed successively.

With reference to FIG. 5, the PD controller 100 is initialized at time t0. At time t1, the detection using the communication line (CC1/CC2) is enabled. At time t2, the PD controller functioning as SRC transitions to the Attached.SRC state (ST13) to start supplying the power to the VBUS 23.

Suppose the voltage of the VBUS 23 increases to vSafe5V from vSafe0V at time t3 that is later than or equal to time t2. The above-described process completes the Source-to-Sink.Attached sequence (step S10). The PowerNegotiation sequence (step S20) then starts.

More specifically, during the PowerNegotiation sequence, the PD controller functioning as SRC changes the voltage of the VBUS 23 to vSrcNew from vSafe5V at the time to receive AcceptMessage from the PD controller functioning as SNK.

The example in FIG. 5 assumes that the PD controller functioning as SRC receives AcceptMessage at time t4. The voltage of the VBUS 23 then increases to vSrcNew.

Suppose the voltage of the VBUS 23 increases to vSrcNew from vSafe5V at time t5 that is later than or equal to time t4. The PowerNegotiation sequence is then completed to supply the electric power to the VBUS 23 at the voltage of vSrcNew.

The USB PD standard specifies that the voltage of the VBUS 23 must be increased to vSrcNew from vSafe5V within tSrcSettle after AcceptMessage is received. The present USB PD standard specifies tSrcSettle as 275 ms. This restriction will be described later.

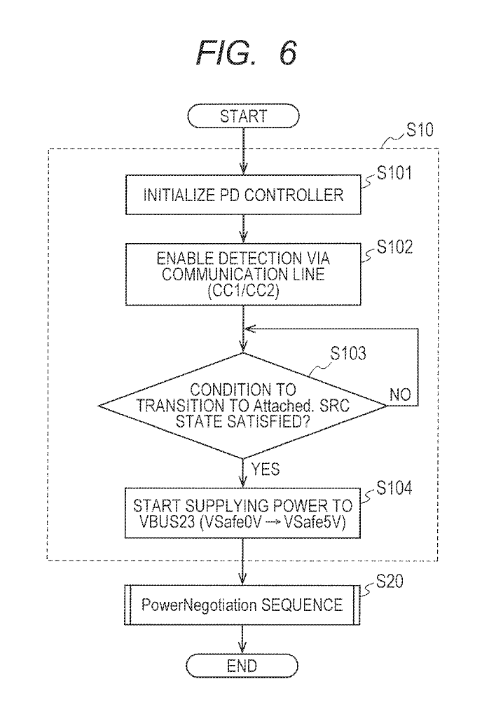

FIG. 6 is a flowchart illustrating more detailed contents of the Source-to-Sink.Attached sequence and the PowerNegotiation sequence to change a voltage. With reference to FIG. 6, the PD controller functioning as SRC initializes the local controller (step S101: time t0 in FIG. 5). The PD controller functioning as SRC then enables the detection using the communication line (CC1/CC2) (step S102: time t1 in FIG. 5).

The PD controller functioning as SRC waits until a condition to transition to the Attached.SRC is satisfied (step S103). Suppose a condition to transition to the Attached.SRC is satisfied (YES in step S103). The PD controller functioning as SRC then starts supplying the power to the VBUS 23 (step S104: times t2 to t3 in FIG. 5).

The above-described process completes the Source-to-Sink.Attached sequence (step S10).

The PD controller functioning as SRC performs the PowerNegotiation sequence to moreover increase the voltage (step S20).

### C. New Issue and Solution

The description below explains a new issue resulting from a combination of the electric power supply according to the USB Type-C standard and the USB PD standard described above with the wireless power feed according to the Qi standard.

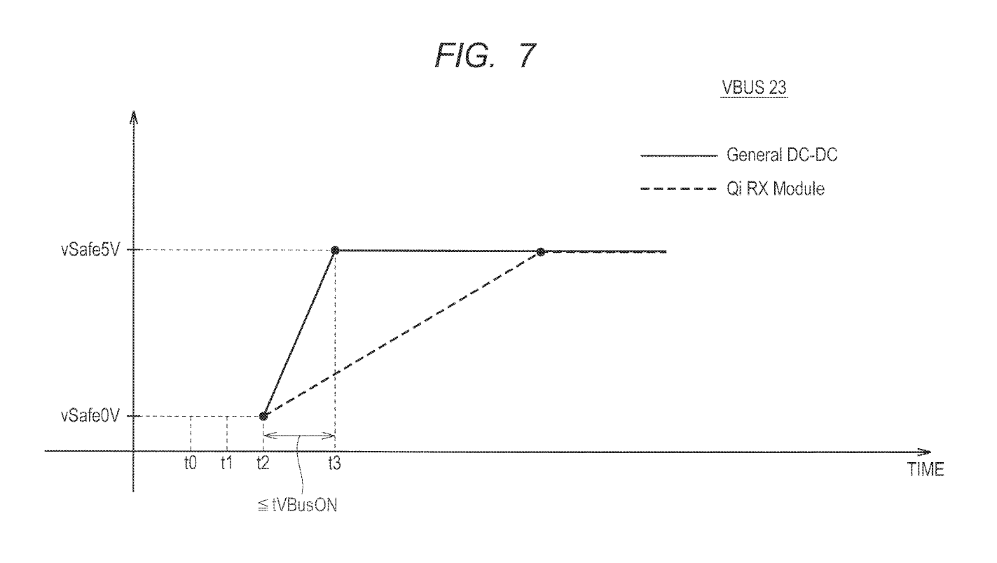

FIG. 7 is a time chart illustrating voltage changes on the VBUS 23 when the sequence in FIG. 6 is performed by using electric power output from the VOUT 127 of the reception module 120 for the wireless power feed function. FIG. 7 illustrates voltage changes during the use of the reception module 120 (Qi RX Module indicated by a broken line) and the use of an ordinary DC-DC converter (General DC-DC indicated by a solid line) for the purpose of comparison.

According to the Qi standard, the voltage value of the VOUT 127 for the reception module 120 changes slowly after a voltage change directive is issued to the reception module 120 via the I2C interface 126. Therefore, it is impossible to satisfy the timing restriction (tVBusON) on the voltage change according to the USB Type-C standard and the timing restriction (tSrcSettle) on the voltage change according to the USB PD standard.

As illustrated in FIG. 7, it is impossible to satisfy the timing restriction (tVBusON) on the voltage change according to the USB Type-C standard when electric power output from the VOUT 127 for the reception module 120 is used. Accordingly, the subsequent PowerNegotiation sequence cannot start.

While a new issue results from the use of the wireless power feed as described above, the present embodiment describes a solution to satisfy the timing restriction (tVBusON) on the voltage change according to the USB Type-C standard. That is, the embodiment describes a technique of supplying vSafe5V to the VBUS 23 within tVBusON after the transition to the Attached.SRC state.

The timing restriction (tSrcSettle) on the voltage change according to the USB PD standard can be solved by defining a new mode according to Alternate Mode permitted in the USB PD standard. That is, the transition to the newly defined mode is specified in the PowerNegotiation sequence that is performed after completion of the Source-to-Sink.Attached sequence. In addition, the new mode performs a sequence that changes the voltage according to a vendor-defined protocol. The vendor-defined protocol can use more relaxed timing restrictions instead of the timing restriction (tSrcSettle) on the voltage change specified in the USB PD standard. It is possible to solve issues resulting from the timing restriction (tSrcSettle) on the voltage change according to the USB PD standard.

### D. First Embodiment

The first embodiment uses a sequence that transitions to the Attached. SRC state after a sufficient increase in the voltage value of the VOUT 127 for the reception module 120 in order to solve the issue concerning the timing restriction (tVBusON) on the voltage change according to the USB Type-C standard.

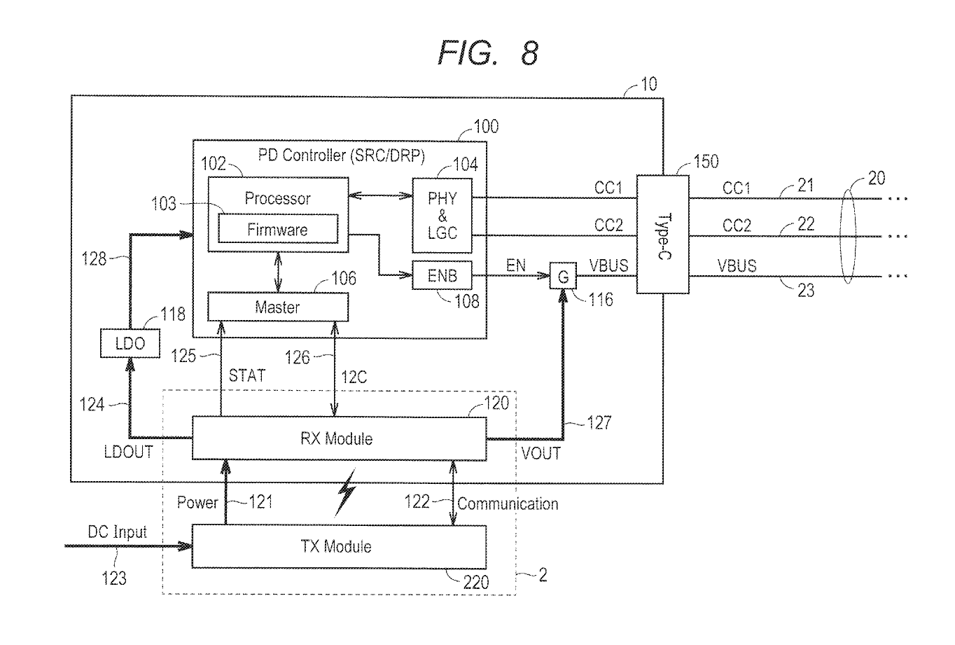

FIG. 8 is a schematic diagram illustrating a hardware configuration of the power supply device 10 according to the first embodiment. The mutually corresponding configurations in FIGS. 8 and 1 are designated by the same reference numerals.

With reference to FIG. 8, the power supply device 10 includes a PD controller (PD Controller) 100 comparable to the USB PD function, a gate circuit 116, a linear regulator 118, a reception module (RX Module) 120 for wireless power feed, and a connector 150. The connector 150 represents a USB Type-C port according to the USB Type-C standard.

The PD controller 100 of the power supply device 10 functions as SRC or DRP. More specifically, the PD controller 100 includes a processor 102, a signal transmission module 104, a master module 106, and an activation module 108.

The processor 102 is comparable to a sequence controller and is connected to the signal transmission module 104, the master module 106, and the activation module 108. The processor 102 performs firmware 103 as an example of the control program and thereby enables the PD controller 100 to perform processes and provide functions. The processor 102 and the firmware 103 can be used for implementation to more easily correct or upgrade the sequences.

The processor 102 controls execution of the Source-to-Sink.Attached sequence and the PowerNegotiation sequence as described above.

The signal transmission module 104 exchanges signals with a connection destination via the communication lines (the first communication line (CC1) 21 and the second communication line (CC2) 22) in the USB cable 20. More specifically, the signal transmission module 104 includes a transmission and reception module to exchange signals with the connection destination and a sequence logic needed to exchange signals.

The signal transmission module 104 can detect the presence of a connection destination based on characteristic changes occurring on the communication lines (the first communication line (CC1) 21 and the second communication line (CC2) 22). More specifically, the signal transmission module 104 includes a resistor coupled to the communication line (see FIG. 10) and is capable of detecting the presence of a connection destination based on a resistance value that appears on the communication line and is indicated by the resistor. Alternatively, the presence of a connection destination may be detected based on a potential change that occurs on the communication line due to an electronic connection.

The master module 106 is comparable to a power supply control module to control the reception module 120 as a power supply unit. Specifically, the master module 106 exchanges control signals with the reception module 120 via the I2C interface 126. For example, the master module 106 is capable of providing the reception module 120 with a voltage change directive or an output stop directive concerning voltage values of the VOUT 127.

The activation module 108 provides the gate circuit 116 with enable signal EN according to a directive from the processor 102.

The gate circuit 116 is placed between the reception module 120 (power supply unit) and the VBUS 23 (electric power line). That is, the gate circuit 116 is provided as a switch that electrically couples the VDOUT 127 of the reception module 120 with the VBUS 23 as the electric power line. The gate circuit 116 electrically couples the VDOUT 127 with the VBUS 23 during a period in which enable signal EN is supplied from the PD controller 100. That is, the processor 102 provides the gate circuit 116 with enable signal EN and thereby electrically couples the reception module 120 (power supply unit) with the VBUS 23 (electric power line).

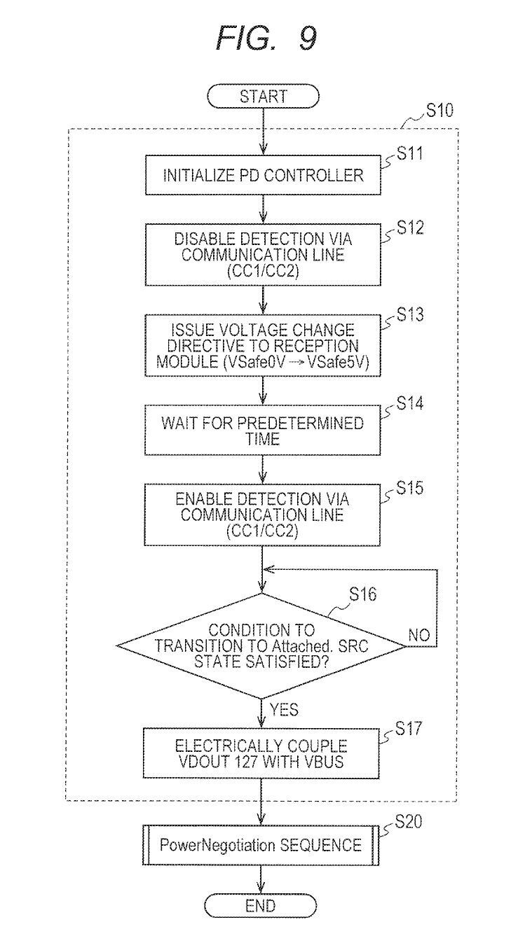

FIG. 9 is a flowchart illustrating a major part of the procedure as a connection sequence performed by the PD controller 100 of the power supply device 10 according to the first embodiment. The procedure illustrated in FIG. 9 is provided as a partial modification of a standard sequence specified in the USB Type-C standard. Basically, the processor 102 of the PD controller 100 performs the firmware 103 as a control program to implement steps in FIG. 9. Therefore, the processor 102 is basically a subject to perform the steps in FIG. 9.

The process represented by the flowchart in FIG. 9 is performed when the presence of a connection destination is detected although the connection to the connection destination is not established. The PD controller 100 initializes the local controller (step S11).

The PD controller 100 once disables the connection via the communication line (CC1/CC2) (step S12). The PD controller 100 provides the reception module 120 with a voltage change directive to change the voltage value of the VDOUT 127 to vSafe5V via the I2C interface 126 (step S13).

As above, suppose the presence of the connection destination is detected during the process in steps S11 through S13 although the connection to the connection destination is not established. The PD controller 100 then disables the function of the signal transmission module 104 to detect the presence of the connection destination and instructs the reception module 120 to output vSafe5V (first voltage).

The PD controller 100 provides the reception module 120 with the voltage change directive and then waits for a predetermined time (step S14). Step 14 is comparable to a process to determine that the VDOUT 127 of reception module 120 reaches vSafe5V.

The wait time in step S14 is determined in consideration of the time required to increase the VOUT 127 of the reception module 120 to vSafe5V from vSafe0V. The voltage change time required from vSafe0V to vSafe5V is referred to as tSrcVout (>tVBusON). The time tSrcVout can be experimentally predetermined. A timer module provided for the PD controller 100 can implement the process in step S14. As above, the PD controller 100 (processor 102) determines that the VDOUT 127 (output voltage) of the reception module 120 (power supply unit) reaches vSafe5V when the predetermined time tSrcVout elapses after the output (voltage change directive) of vSafe5V (first voltage) is issued to the reception module 120 (power supply unit).

The PD controller 100 enables the detection via the communication line (CC1/CC2) (step S15) and waits until a condition to transition to the Attached.SRC state is satisfied (step S16).

Suppose a condition to transition to the Attached.SRC state is satisfied (YES in S16). The PD controller 100 then provides the gate circuit 116 with enable signal EN and electrically couples the VDOUT 127 of the reception module 120 with the VBUS 23 as the electric power line (step S17). This starts supplying the electric power to the VBUS 23 from the reception module 120.

During the process in steps S11 through S13 as above, the PD controller 100 electrically couples the reception module 120 with the VBUS 23 (electric power line) when determining that the VOUT 127 (output voltage) of the reception module 120 reaches vSafe5V (first voltage).

The above-described process completes the Source-to-Sink.Attached sequence (step S10), namely, the sequence to establish the connection with the connection destination.

The PD controller 100 then performs the PowerNegotiation sequence to moreover increase the voltage (step S20). After the VOUT 127 (output voltage) of the reception module 120 is electrically coupled with the VBUS 23 (electric power line), the PD controller 100 negotiates with the connection destination to increase the voltage of the VBUS 23 (electric power line) from vSafe5V (first voltage) to vSrcNew (second voltage).

FIG. 10 is a schematic diagram illustrating a circuit configuration of the signal transmission module 104 in the PD controller 100 of the power supply device 10 according to the first embodiment. With reference to FIG. 10, the PD controller 100 includes a first transmission and reception module 1041 and a second transmission and reception module 1042 associated with the first communication line (CC1) 21 and the second communication line (CC2) 22, respectively. The first transmission and reception module 1041 outputs data received via a first communication line 21 to the processor 102 and transmits data from the processor 102 via the first communication line 21. Similarly, the second transmission and reception module 1042 outputs data received via a second communication line 22 to the processor 102 and transmits data from the processor 102 via the second communication line 22.

A pull-up resistor 1043 having resistance value Rp is coupled between the first communication line 21 and power supply potential Vs. A pull-down resistor 1044 having resistance value Rd is coupled between the first communication line 21 and ground GND. Similarly, a pull-up resistor 1045 having resistance value Rp is coupled between the second communication line 22 and power supply potential Vs. A pull-up resistor 1046 having resistance value Rd is coupled between the second communication line 22 and ground GND. When establishing a connection, the two devices mutually detect resistance values Rp and Rd available on the first communication line 21 and the second communication line 22 to detect the presence of the devices as connection destinations.

The processor 102 is capable of transmitting an Enable/Disenable signal that enables or disables operation of the first transmission and reception module 1041 and the second transmission and reception module 1042. Basically, the processor 102 provides a Disenable signal to the first transmission and reception module 1041 and the second transmission and reception module 1042, making it possible to implement the above-described process of disabling the detection via the communication line (CC1/CC2) (step S12 in FIG. 9). This function of enabling or disabling the detection via the communication line is known as “Disabling/Enabling CCDetection.”

An alternative technique is to delete electric connection between the first communication line 21 and the pull-up resistor 1043 and/or the pull-down resistor 1044 or electric connection between the second communication line 22 and the pull-up resistor 1045 and/or the pull-down resistor 1046, for example.

Any technique can be used to implement the process (step S12 in FIG. 9) that disables the detection via the communication line (CC1/CC2).

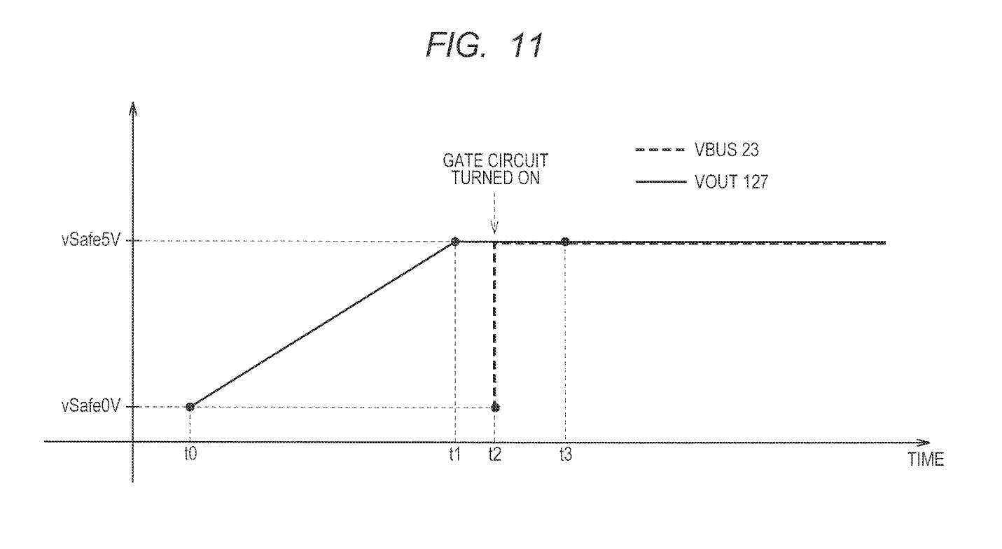

FIG. 11 is a time chart illustrating voltage changes in the VBUS 23 and the VOUT 127 occurring when the PD controller 100 of the power supply device 10 according to the first embodiment performs a connection sequence.

At time t0 in FIG. 11, the PD controller 100 is initialized (step S11 in FIG. 9), the detection via the communication line (CC1/CC2) is disabled (step S12 in FIG. 9), and the voltage change directive is output to the reception module (step S13 in FIG. 9). At time t0 and later, the reception module 120 enables an output to the VOUT 127 and increases the output voltage from vSafe0V to vSafe5V. Suppose the VOUT 127 of the reception module 120 reaches vSafe5V at time t1 after the wait for the predetermined time interval (step S14 in FIG. 9) elapsed from time t0. At time t1, the detection via the communication line (CC1/CC2) is enabled (step S15 in FIG. 9) and it is determined whether the condition of transition to the Attached.SRC state is satisfied (step S16).

At time rt2, suppose the specified condition is satisfied to cause a successful transition to the (YES in S16 in FIG. 9). The transition to the Attached.SRC state provides enable signal EN to the gate circuit 116 (step S17 in FIG. 9) and electrically couples the VDOUT 127 with the VBUS 23. The voltage of the VBUS 23 promptly increases to VSafe5V.

The voltage of the VBUS 23 is set to VSafe5V at time t3 after a lapse of tVBusON from time t2. The Source-to-Sink.Attached sequence (step S10) terminates successfully.

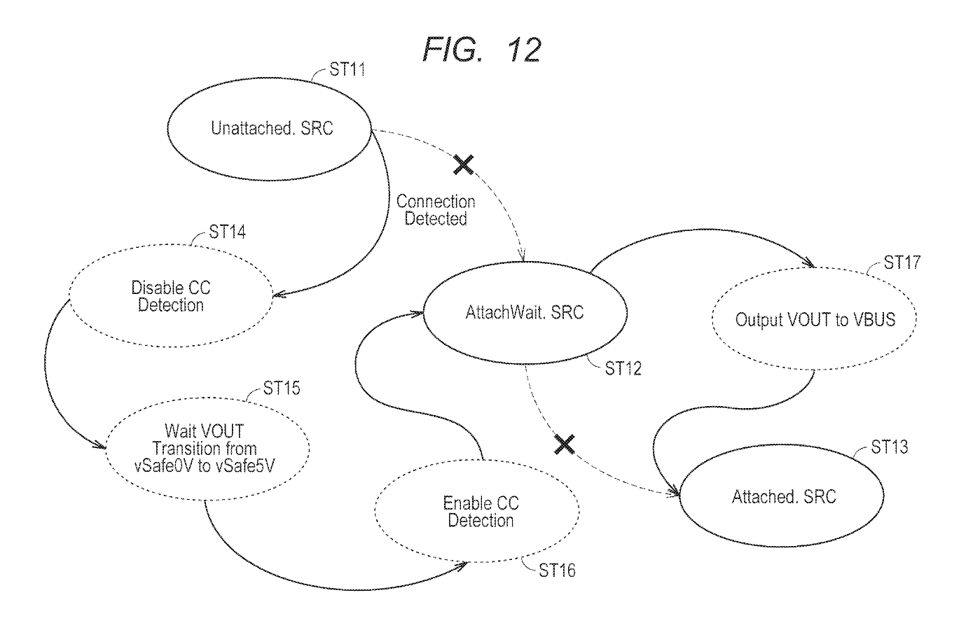

FIG. 12 is a diagram illustrating state transition when the PD controller 100 of the power supply device 10 according to the first embodiment performs the Source-to-Sink.Attached sequence. The procedure illustrated in FIG. 12 is provided as a partial modification of a standard state transition specified in the USB Type-C standard. In the state transition as illustrated in FIG. 12, a path including an arrow between states represents the state transition direction.

As seen from FIG. 12, three new states such as a DisableCCDetection state (ST14), a WaitVOUTTransitionfromvSafe0VtovSafe5V state (ST15), and an EnableCCDetection state (ST16) are added between the Unattach.SRC state (ST11) and the AttachWait.SRC state (ST12) as the initial states. These three states correspond to step S12, S14, and S15 in FIG. 9, respectively.

An OutputVOUTtoVBUS state (ST17) is newly added between the AttachWait.SRC state (ST12) and the Attached.SRC state (ST13). This state is comparable to S16 in FIG. 9.

The above-described embodiment once disables the detection function and increases the voltage of the VOUT 127 of the reception module 120 to vSafe5V before the transition to the Attached. SRC state (ST3) by using the function to enable or disable the detection via the communication line (CC1/CC2). The detection function is enabled after the voltage of the VOUT 127 of the reception module 120 increases to vSafe5V, making it possible to easily satisfy the timing restriction (tVBusON) on the transition to Attached.SRC (ST3).

A configuration may supply external devices with electric power supplied from the wireless power feed according to the Qi standard. Even such a configuration can satisfy the timing restrictions specified in the USB Type-C standard and the USB PD standard by using the PD controller 100 according to the first embodiment. The configuration of the wireless power feed according to the Qi standard can be easily built in USB-mounted instruments.

The use of the PD controller 100 according to the first embodiment can reduce system development costs in changing existing USB devices to USB PD compatible devices

### E. First Modification of the First Embodiment

According to the above-described first embodiment, the PD controller provides the reception module 120 with the voltage change time, waits for experimentally predetermined tSrcVout, enables the detection via the communication line (CC1/CC2), and then transitions to the Attached.SRC state (steps S15 and S16 in FIG. 9). In this manner, it may be favorable to statically settle the timing to transition to the Attached.SRC state. However, tSrcVout may vary depending on how the transmission module 220 and the reception module 120 are coupled.

As a solution, it may be favorable to monitor the size of the VOUT 127 output from the reception module 120 and settle the timing to enable the detection via the communication line (CC1/CC2).

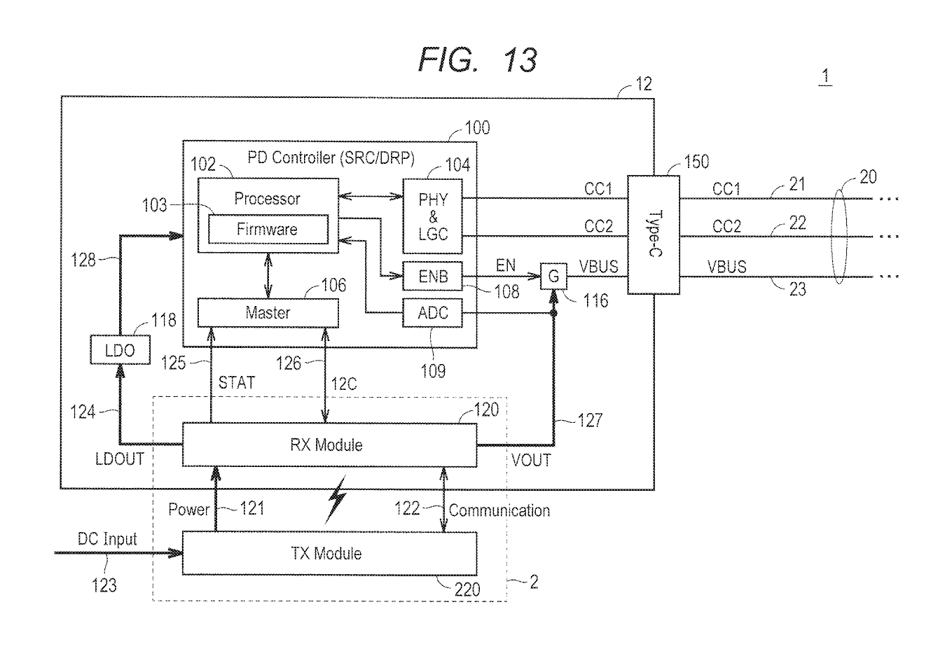

FIG. 13 is a schematic diagram illustrating a hardware configuration of the power supply device 10 according to the first modification of the first embodiment. The example hardware configuration in FIG. 13 differs from the power supply device 10 in FIG. 8 in that an AD converter 109 is added.

The AD converter 109 corresponds to a detector that detects the VDOUT 127 (output voltage) of the reception module 120 (power supply unit). The AD converter 109 is coupled to the VDOUT 127 of the reception module 120 and detects a voltage value of the VDOUT 127. A detection result (voltage value) from the AD converter 109 is provided to the processor 102.

The processor 102 issues a voltage change directive to the reception module 120 and then determines whether a voltage value of the VOUT 127 from the reception module 120 reaches vSafe5V. That is, the PD controller 100 (processor 102) determines whether the VDOUT 127 (output voltage) of the reception module 120 (power supply unit) reaches vSafe5V, based on the output voltage detected by the AD converter 109 (detector).

When the voltage value of the VOUT 127 reaches vSafe5V, the detection via the communication line (CC1/CC2) is enabled to perform the process to transition to the Attached.SRC state.

The first modification of the first embodiment replaces the process to wait for the predetermined time (step S14) in the procedure as the connection sequence in FIG. 9 above with a process to wait until the voltage value of the VOUT 127 reaches vSafe5V.

The other processes and functions are similar to the above-described first embodiment and a detailed description is omitted.

The first modification of the first embodiment monitors the actual VDOUT 127 (output voltage) from the reception module 120 as a power supply unit. It is possible to appropriately proceed with sequences even when a situation of the wireless power feed requires more time to increase the voltage of the VDOUT 127.

### F. Second Modification of the First Embodiment

As above, the first modification of the first embodiment illustrates the method of directly monitoring the voltage value of the VDOUT 127 from the reception module 120. The communication with the reception module 120 may determine the state of the VDOUT 127.

More specifically, the processor 102 allows the master module 106 to provide the reception module 120 with a directive to report the current value of the VOUT 127 along with the voltage change directive via the I2C interface 126. Based on the directive, the reception module 120 periodically transmits the current value of the VOUT 127 to the master module 106 via the I2C interface 126. The processor 102 determines whether the voltage value of the VOUT 127 reaches vSafe5V, based on a voltage value reported from the reception module 120. That is, the PD controller 100 (processor 102) determines whether the VDOUT 127 (output voltage) of the reception module 120 (power supply unit) reaches vSafe5V, based on the VDOUT 127 (output voltage) of the reception module 120 (power supply unit) acquired through communication with the reception module 120 (power supply unit).

When the voltage value of the VOUT 127 reaches vSafe5V, the directive to stop notifying the current value of the VOUT 127 is transmitted. In addition, the detection via the communication line (CC1/CC2) is enabled to perform the process of transitioning to the Attached.SRC state.

The second modification of the first embodiment replaces the process to wait for the predetermined time (step S14) in the procedure as the connection sequence in FIG. 9 above with a process to wait until the current value of the VOUT 127 notified from the reception module 120 reaches vSafe5V.

The other processes and functions are similar to the above-described first embodiment and a detailed description is omitted.

In the example described above, the reception module 120 periodically transmits the current value of the VOUT 127. Instead, the PD controller 100 may periodically inquire the reception module 120 (polling).

The second modification of the first embodiment monitors the actual VDOUT 127 (output voltage) from the reception module 120 as a power supply unit. It is possible to appropriately proceed with sequences even when a situation of the wireless power feed requires more time to increase the voltage of the VDOUT 127. It is also possible to prevent an increase in overall system costs because there is no need for an additional configuration such as the AD converter 109 described in the first modification of the first embodiment.

### G. Second Embodiment

The first embodiment and its modifications have described the configuration to receive electric power based on the wireless power feed according to the Qi standard. However, the above-described sequence is applicable when an existing power supply unit is used.

For example, suppose an ordinary DC-DC converter generates an electric power that is then supplied via the USB cable 20. In this case, the DC-DC converter may have poor response performance and may not satisfy the timing restriction (tVBusON) on the voltage change according to the USB Type-C standard and the timing restriction (tSrcSettle) on the voltage change according to the USB PD standard. In such a case, it is possible to apply the sequence according to the above-described first embodiment.

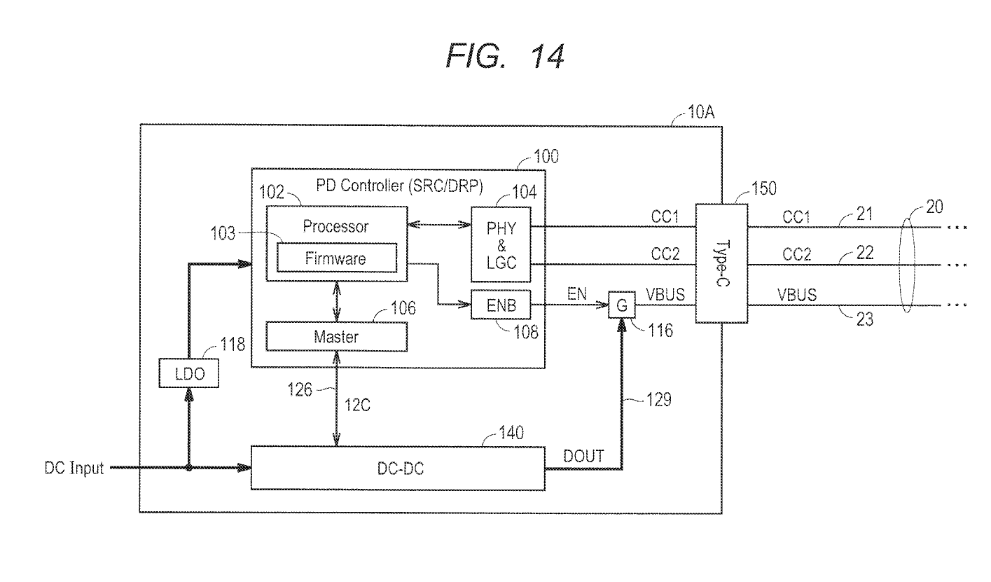

FIG. 14 is a schematic diagram illustrating a hardware configuration of the power supply device 12 according to the second embodiment. In FIG. 14, the power supply device 12 illustrated in FIG. 14 differs from the power supply device 10 illustrated in FIG. 8 in that the reception module 120 used for the wireless power feed is replaced by a converter 140.

The DC-DC converter 140 receives an external direct-current electric power and outputs DOUT 129, namely, a direct-current electric power at any voltage. The DC-DC converter 140 is coupled to the PD controller 100 via the I2C interface 126. The PD controller 100 is capable of providing the voltage change directive to the DC-DC converter 140 at any timing according to a predetermined sequence via the I2C interface 126.

The second embodiment assumes the time (voltage change time) tSrcDout (>tVBusON, tSrcSettle) required to actually increase the DOUT 129 to vSafe5V after the DC-DC converter 140 is provided with the voltage change directive to change vSafe0V to vSafe5V. That is, the power supply system is assumed to be incapable of satisfying the timing restriction because the DC-DC converter 140 has relatively poor response performance.

The use of the above-described sequence can embody an electric power supply according to the USB Type-C standard and the USB PD standard even when the DC-DC converter 140 to be used has relatively poor response performance.

The other processes and functions are similar to the above-described first embodiment and a detailed description is omitted.

The use of the PD controller 100 according to the second embodiment can perform a sequence according to the standard and establish the connection to a connection destination even when the power supply uses a DC-DC converter whose specification is incapable of satisfying the timing restrictions in conformity with the USB Type-C standard and the USB PD standard.

### H. Modifications of the Second Embodiment

The first and second modifications of the first embodiment are also applicable to the above-described second embodiment. A detailed description is omitted here.

### I. Third Embodiment

The PD controller 100 according to the present embodiment described above is applicable to a mobile device including a battery. The description below explains a mobile device 30 including the PD controller 100 according to the present embodiment. The mobile device 30 is available as a portable battery, a smartphone, a tablet, or a router, for example.

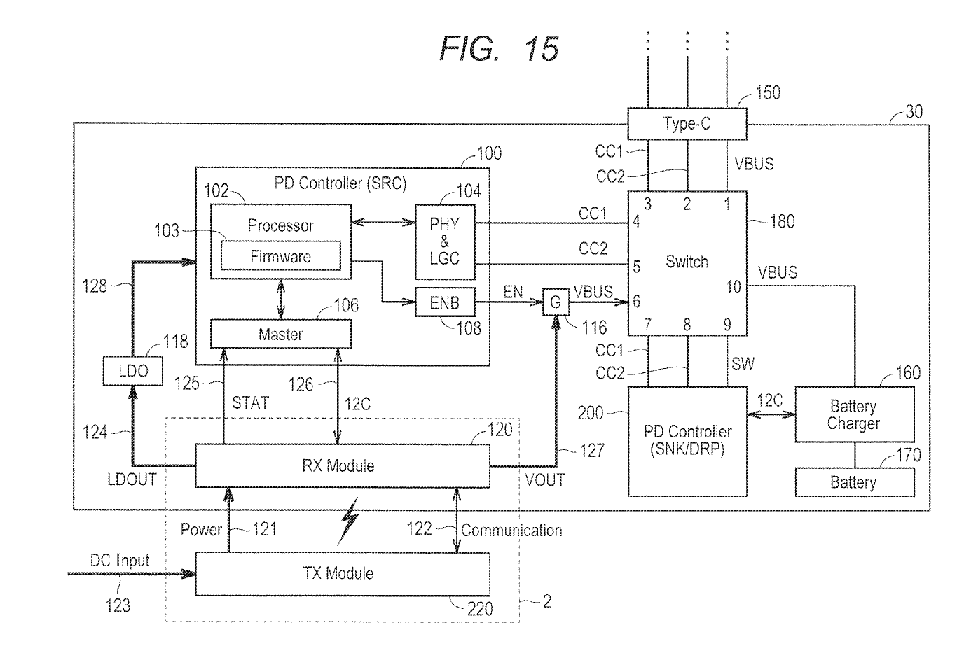

FIG. 15 is a schematic diagram illustrating a hardware configuration of the mobile device 30 according to the third embodiment. With reference to FIG. 15, the mobile device 30 includes a battery charger 160, a battery 170, a switch 180, and a PD controller 200 in addition to the configuration of the power supply device 10 illustrated in FIG. 8.

As will be described later, the battery charger 160 charges the battery 170 by using the electric power supplied from the wireless power feed (reception module 120) or the electric power supplied via the USB cable coupled to the connector 150. The battery charger 160 discharges the electric power charged in the battery 170 as needed.

Based on user manipulations, the switch 180 electrically couples two PD controllers (unshown) of any external devices coupled via the USB cables coupled to the PD controller 100, the PD controller 200, and the connector 150. That is, the switch 180 is used to switch power delivery and reception modes and power feed directions.

The description below explains three modes of the power delivery and reception operation provided by the mobile device 30 as illustrated in FIG. 15.

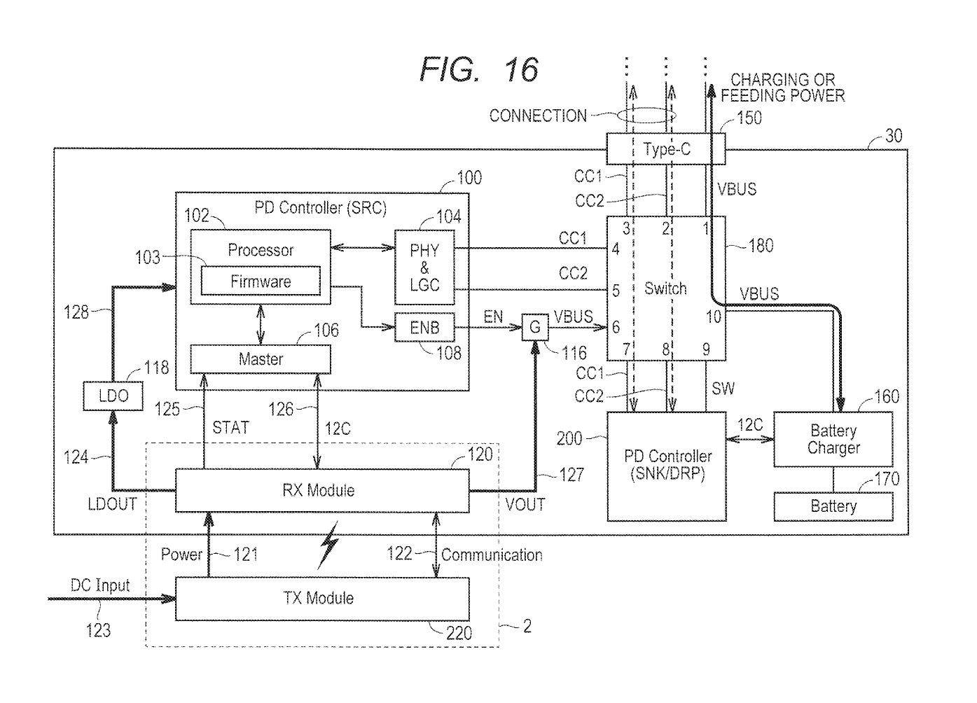

FIG. 16 is a schematic diagram illustrating a first mode of the power delivery and reception operation on the mobile device 30 according to the third embodiment. The first mode illustrated in FIG. 16 provides the power delivery and reception operation that exchanges an electric power between the battery 170 included in the mobile device 30 and any external device.

In the first mode, the switch 180 electrically couples the communication line (CC1/CC2) of the PD controller 200 with the communication line (CC1/CC2) of the external device and electrically couples VBUS from the external device with the battery charger 160 (and the battery 170).

The PD controller 200 establishes a connection with a PD controller of the external device in accordance with a standard sequence specified in the USB Type-C standard and a standard sequence specified in the USB PD standard.

A negotiation between the PD controller 200 and the external device can selectively feed power to the battery 170 from the external device (to charge the battery 170) and to the external device from the battery 170 (to discharge the battery 170).

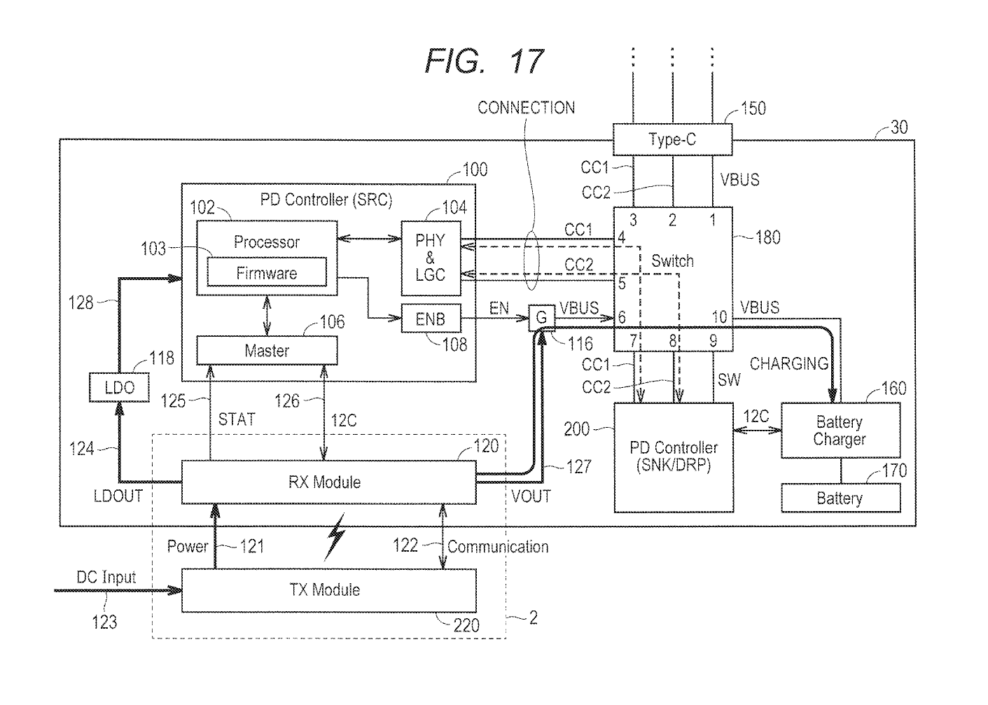

FIG. 17 is a schematic diagram illustrating a second mode of power delivery and reception operation on the mobile device 30 according to the third embodiment. The second mode illustrated in FIG. 17 provides the power delivery and reception operation that charges the battery 170 by using the electric power transmitted from the transmission module 220 under control of the wireless power feed system 2.

In the second mode, the switch 180 electrically couples the communication line (CC1/CC2) of the PD controller 100 with the communication line (CC1/CC2) of the PD controller 200 and electrically couples VBUS from the reception module 120 with the battery charger 160 (and the battery 170).

The PD controller 100 establishes a connection with the PD controller 200 based on a sequence according to the present embodiment described above. Establishing the connection between the PD controller 100 and the PD controller 200 makes it possible to supply an external electric power transmitted by the wireless power feed system 2 to the battery 170 (to charge the battery 170).

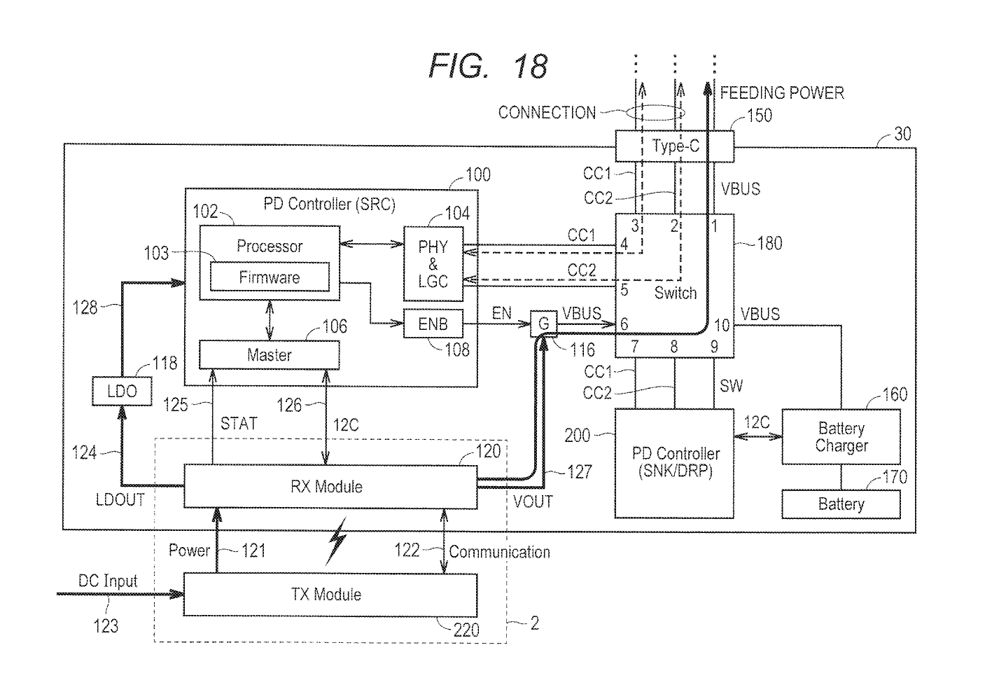

FIG. 18 is a schematic diagram illustrating a third mode of power delivery and reception operation on the mobile device 30 according to the third embodiment. The third mode illustrated in FIG. 18 provides the power delivery and reception operation that supplies an electric power to any external device by using the electric power transmitted from the transmission module 220 under control of the wireless power feed system 2.

In the third mode, the switch 180 electrically couples the communication line (CC1/CC2) of the PD controller 100 with the communication line (CC1/CC2) as a communication line of the external device and electrically couples the reception module 120 with VBUS from the external device.

The PD controller 100 establishes a connection with the external device based on a sequence according to the present embodiment described above. Establishing the connection between the PD controller 100 and the external device makes it possible to supply an external electric power transmitted by the wireless power feed system 2 to any external device.

The third embodiment can easily provide the wireless power feed function for existing mobile devices such as portable batteries, smartphones, tablets, and routers. It is possible to provide devices capable of versatile usage patterns. It is also possible to reduce system development costs in developing the devices capable of versatile usage patterns.

### J. Installation Patterns

The PD controller 100 according to the present embodiment performs the processes and provides the functions described above by allowing the processor 102 to execute the firmware 103. All or part of this software implementation may be replaced by hardware implementation. The hardware implementation, if applicable, may use a hard-wired device such as ASIC (Application Specific Integrated Circuit) or FPGA (Field-Programmable Gate Array), for example.

The firmware 103 executed by the processor 102 is provided as a control program that can be installed or updated from the outside.

For example, the firmware 103 may be stored in a non-transitory recording medium for distribution and may be installed or updated in a storage area of the PD controller 100. The non-transitory recording medium may be available as an optical recording medium such as optical disks, a semiconductor recording medium such as flash memory, a magnetic recording medium such as hard disks or storage tape, or a magneto-optical recording medium such as MO (Magneto-Optical disk). That is, the present embodiment may include a computer-readable control program to embody the above-described processes and functions and a recording medium storing the control program.

Alternatively, the firmware 103 may be downloaded from a server via the Internet or an intranet.

Those skilled in the art may design the PD controller according to the present embodiment and a device including the PD controller by appropriately using a technology suited to the times when the present embodiment is implemented.

### K. Overview

A configuration may supply external devices with electric power supplied from the wireless power feed according to the Qi standard. According to the present embodiment, even such a configuration can satisfy the timing restrictions specified in the USB Type-C standard and the USB PD standard. The configuration of the wireless power feed according to the Qi standard can be easily built in USB-mounted instruments.

The use of the PD controller 100 according to the first embodiment can reduce system development costs in changing an existing USB device to a USB PD compatible device.

While there have been described the specific preferred embodiments of the present invention created by the inventors, it is to be distinctly understood that the present invention is not limited thereto but may be otherwise variously embodied within the spirit and scope of the invention.

What is claimed is:

1. A power supply device, comprising:
a controller that executes a sequence compliant with a USB (Universal Serial Bus) standard and establishes a connection with a connection destination,
a connector that one end of a USB cable is connected with, the other end of the USB cable is connected with the connection destination,
a power supply unit that supplies electric power via an electric power line inside the USB cable and
a gate circuit placed between the power supply unit and the electric power line,
wherein the power supply unit receives an electric power from outside based on wireless power feed,
wherein the controller comprises:
a signal transmission module that exchanges a signal with the connection destination via a communication line inside the USB cable,
a power supply control module that controls the power supply unit and
a sequence controller,
wherein the signal transmission module is capable of detecting the existence of the connection destination based on an electric characteristic change occurring on the communication line and
wherein the sequence controller provides the gate circuit with an enable signal to electrically couple the power supply unit with the electric power line.

2. The power supply device according to claim 1, further comprising:
a detector that detects an output voltage from the power supply unit,
wherein the sequence controller instructs the power supply unit to output a first voltage and determines whether an output voltage from the power supply unit reaches a first voltage, based on an output voltage detected by the detector.

3. A controller that executes a sequence compliant with a USB (Universal Serial Bus) standard and establishes a connection with a connection destination, comprising:
a signal transmission module that exchanges a signal with the connection destination via a communication line inside a USB cable, the signal transmission module being capable of detecting the existence of the connection destination based on an electric characteristic change occurring on the communication line;
a power supply control module that controls a power supply unit that supplies electric power via an electric power line inside the USB cable; and
a sequence controller,
wherein, when the existence of the connection destination is detected while no connection is established with the connection destination, the sequence controller disables the function of the signal transmission module to detect the existence of the connection destination,
instructs the power supply unit to output a first voltage, and
electrically couples the power supply unit with the electric power line when it is determined that an output voltage from the power supply unit reaches the first voltage.

4. The controller according to claim 3, further comprising:
a gate circuit placed between the power supply unit and the electric power line,
wherein the sequence controller provides the gate circuit with an enable signal to electrically couple the power supply unit with the electric power line.

5. The controller according to claim 3,
wherein the sequence controller determines that an output voltage from the power supply unit reaches the first voltage when a predetermined time elapses from a time point to issue an instruction to output a first voltage to the power supply unit.

6. The controller according to claim 3, further comprising:
a detector that detects an output voltage from the power supply unit,
wherein the sequence controller determines whether an output voltage from the power supply unit reaches the first voltage, based on an output voltage detected by the detector.

7. The controller according to claim 3,
wherein the sequence controller determines whether an output voltage from the power supply unit reaches the first voltage, based on information about an output voltage from the power supply unit, the information being acquired by communication with the power supply unit.

8. The controller according to claim 3,
wherein the power supply unit receives an electric power from outside based on wireless power feed.

9. The controller according to claim 3, further comprising:
a processor coupled to the signal transmission module and the power supply control module,
wherein the processor executes a control computer readable storage medium to implement the sequence controller.

10. The controller according to claim 3,
wherein, after the power supply unit and the electric power line are electrically coupled, the sequence controller increases a voltage of the electric power line to a second voltage from the first voltage based on a negotiation with the connection destination.

11. A control computer readable storage medium executed in a processor of a controller that executes a sequence compliant with a USB (Universal Serial Bus) standard and establishes a connection with a connection destination,
wherein the controller includes:
a signal transmission module that exchanges a signal with the connection destination via a communication line in a USB cable, the signal transmission module being capable of detecting the existence of the connection destination based on an electric characteristic change occurring on the communication line; and
a power supply control module that controls a power supply unit that supplies electric power via an electric power line in the USB cable, and
wherein the control computer readable storage medium allows the processor to perform the steps of:
disabling the function of the signal transmission module to detect the existence of the connection destination when the existence of the connection destination is detected while no connection is established with the connection destination;
after the disabling step, instructing the power supply unit to output a first voltage; and
electrically coupling the power supply unit with the electric power line when it is determined that an output voltage from the power supply unit reaches the first voltage.
